(19) United States
(12) Patent Application Publication
(10) Pub. No.: US 2015/0064361 A1
(43) Pub. Date: Mar. 5, 2015

(54) UV treatment for ALD film densification

(71) Applicant: Intermolecular Inc., San Jose, CA (US)

(72) Inventors: Frank Greer, Pasadena, CA (US); Amol Joshi, Sunnyvale, CA (US); Kevin Kashefi, San Jose, CA (US)

(73) Assignee: Intermolecular Inc., San Jose, CA (US)

(21) Appl. No.: 14/018,112

(22) Filed: Sep. 4, 2013

(51) Int. Cl. B05D 3/06

(52) U.S. Cl. CPC B05D 3/067
USPC 427/509

(57) ABSTRACT

Irradiation with ultraviolet (UV) light during atomic layer deposition (ALD) can be used to cleave unwanted bonds on the layer being formed (e.g., trapped precursor ligands or process-gas molecules). Alternatively, the UV irradiation can be used to excite the targeted bonds so they may be more easily cleaved by other means. The use of UV may enable the formation of low-defect-density films at lower deposition temperatures (e.g., <250 C), or reduce the need for a high-temperature post-deposition anneal, improving the quality of devices formed on heat-sensitive materials such as germanium.

### BACKGROUND

Related fields include the formation of thin films by atomic layer deposition (ALD), and the curing, densification, and other treatments of thin films using ultraviolet (UV) light.

Ultraviolet wavelengths correspond to the energies of a variety of molecular bonds. In semiconductors, glasses, polymers and other substances, UV radiation can be used to break undesired chemical bonds (e.g., unstable bonds) so that desired bonds (e.g., stable bonds) can replace them. For example, thin films can be densified by exposure to UV radiation tuned to break undesired bonds that disrupt the film's lattice structure (e.g., silanol Si—O—H bonds in silicon oxide) so that they may be replaced with more desirable lattice-compatible bonds such as Si—O—Si.

UV densification can replace a thermal anneal that would otherwise consume excessive time or require a temperature that might damage a different layer or structure near the film being treated. For instance, germanium (Ge) is less tolerant of high-temperature processes than silicon (Si). While Si process temperatures can exceed 400 C, Ge process temperatures are preferably kept below 200 C. A contributing factor is Ge's growth of native oxides (GeOx) on contact with air or other oxygen-containing materials. Compared to native Si oxides (SiOx), native GeOx grows much more rapidly, is less stable, and does not self-limit. To discourage native-oxide growth, Ge surfaces are commonly passivated with sulfur, but the sulfur will detach from the Ge at temperatures much over 200 C.

This constraint on process temperature limits the potential of other films that can be used to fabricate Ge-based devices. For example, aluminum oxide (Al₂O₃) benefits from higher purity and reduced leakage current if deposited at high temperatures, but these goals must presently be compromised to avoid undoing the sulfur passivation of underlying Ge. A process that would produce Al₂O₃ with the desirable purity and low leakage at a Ge-compatible temperature would advance the development of germanium-based semiconductor devices.

UV treatments are often most effective at the top surface of a material. Many materials strongly absorb UV light, especially in the deep-UV range below about 250 nm, so that the light cannot penetrate very far. Even where it does penetrate, if it breaks an unwanted bond below the surface of a solid material, the molecules may not be sufficiently free to rearrange themselves to form the desired bonds. Therefore, thin-film technology would benefit from a way to break undesired bonds as they are created, while the film is being formed.

UV treatments have been most widely used on thick (micron-scale) films of dielectrics with a dielectric constant less than about 2.5 (“low-k” dielectrics) after the film is fully formed. Higher-k materials have not been able to benefit as much from UV treatment because the absorption length in those materials at UV wavelengths is extremely short, so that only a very thin outer skin is affected by the UV. If a high-k film could be UV-treated during its formation, the effects could be distributed through the film rather than localized at its surface.

### SUMMARY

The following summary presents some concepts in a simplified form as an introduction to the detailed description that follows. It does not necessarily identify key or critical elements and is not intended to reflect a scope of invention.

UV irradiation (150-400 nm or, in some embodiments, 150-300 nm wavelength) is integrated into apparatus and methods for ALD. For example, some commercially available UV light sources emit wavelengths of 185 nm, 193 nm, 248 nm, 254 nm, 262 nm, 266 nm, 308 nm, 337 nm, 349 nm, 356 nm, and 365-395 nm. Some methods irradiate the substrate after or during each cycle or sub-cycle, or after selected numbers of cycles. The process chamber may be evacuated for the UV treatment, or some buffer, reactant, or precursor gases may be present. The UV irradiation spectrum may be chosen for photon energy levels corresponding to specifically targeted undesired bonds (such as trapped precursor waste ligands) known to occur in the film being formed.

The UV radiation may itself cleave targeted bonds on the deposited film. Alternatively, the UV radiation may only excite the undesired bonds to make them easier to cleave by some other process (e.g., collision with a purge-gas particle). The UV treatment may produce, at low process temperatures, defect densities that could otherwise only be achieved at high process temperatures. Some films' deposition temperatures may be reduced by 50-100 C with no loss of quality in characteristics such as leakage current. Some films' required anneal temperature may be lowered as a result of the UV treatment, or they may be able to omit the annealing step entirely.

Some embodiments include placing a substrate in a process chamber, exposing the substrate to a precursor that partially adsorbs onto the surface of the substrate, purging the non-adsorbed portion of the precursor from the process chamber, and irradiating the substrate with ultraviolet light of a wavelength selected to break or excite a targeted bond between the first material and a ligand. If the bond is excited rather than broken, another process may be performed to break the excited bonds, such as exposing the substrate to a gas or plasma activated species. In some embodiments, the bond-breaking gas may be the purge gas and the irradiation may precede the purge.

Some embodiments of the process involve an “A-B” cycle. The “A” cycle includes exposing the substrate to a first precursor, and may include a first purge. The “B” cycle includes exposing the substrate to a second, different precursor, and may include a second purge. In some embodiments, the second material may react with the first material and/or with an ambient gas. The process chamber is purged a second time, and then the substrate is irradiated with ultraviolet light to excite or cleave targeted ligand bonds. If necessary, an additional bond-breaking process is performed, or the bond-breaking and the second purge may be integrated.

The first material may be a metal and the second material may be oxygen. The first precursor may be trimethylaluminum ((CH₃)₃Al, “TMA”), triisobutylaluminum (CH₃)₂CHCH₂]₃Al), tris(dimethylamido)aluminum(III) (Al(N(CH₃)₂)₃), or aluminum tris(2,2,6,6-tetramethyl-3,5-heptanedionate) (Al(OCC(CH₃)₃CHCOC(CH₃)₃)₃), bis(tert-butylcyclopentadienyl)dimethylhafnium(IV), dimethylbis(cyclopentadienyl)hafnium(IV), hafnium(IV) tert-butoxide, tetrakis(diethylamido)hafnium(IV), bis(cyclopentadienyl)zirconium(IV) dihydride, bis(methyl-η5-cyclopentadienyl)methoxymethylzirconium, or dimethylbis(pentamethylcyclopentadienyl)zirconium(IV). The second precursor may be water (H₂O) or ozone (O₃). With these precursors, low-defect-density aluminum oxide may be deposited at less than 250 C, or less than 200 C.

Optionally, the substrate may be exposed to an oxidant “soak” before the first precursor is introduced into the chamber. As used in the ALD art, a “soak” may refer to introducing a gas in the chamber, then closing off the inlets and exhausts for a predetermined time while the gas adsorbs or reacts with the substrate surface. It may also refer to a very long pulse (for instance, about 30 seconds to about 10 minutes). During this type of soak, the gas inflow and outflow may be adjusted to keep the pressure in the chamber substantially (e.g., ±10%) constant. Examples of oxidants include H₂O₂ and H₂O, among others. Optionally, an additional purge may follow the UV irradiation.

An ALD process chamber is equipped with a UV light source positioned to irradiate a substrate. The on/off state, intensity, and spectrum of the UV source may be controllable and its control may be integrated with that of the inlets and exhausts for the precursors and purge gases. The UV source may include a deuterium or mercury-vapor lamp or a laser, and its emission spectrum may include a wavelength between 150 and 300 nm.

An ALD process chamber for high-productivity combinatorial (HPC) substrate processing includes a UV light source and a mechanism to confine the UV light to a site-isolated region (SIR) of the substrate. For example, a mask may cover the substrate outside the SIR, or a source aperture or light-shaping optics may cause the light to irradiate only the SIR. The use, intensity, duration, and spectral characteristics of the UV light thus become another variable, along with precursor chemistry, purge and buffer chemistry, flow rate, temperature, pressure, and the like in a combinatorial screening protocol to determine the best process parameters for the film being formed.

### BRIEF DESCRIPTION OF DRAWINGS

FIGS. 1A and 1B conceptually illustrate the effect of unwanted bonds in films.

FIGS. 2A and 2B conceptually illustrate UV optical cleaving of targeted bonds.

FIGS. 3A-3C conceptually illustrate UV excitation and subsequent cleaving of targeted bonds.

FIG. 4A-4C are example flowcharts of general ALD with UV irradiation treatment.

FIG. 5 is an example flowchart of “A-B cycle” ALD with UV irradiation treatment.

FIG. 6 is a schematic diagram of an ALD chamber equipped for UV treatment of substrates.

FIGS. 7A-7C are schematic diagrams of UV light sources selectively irradiating individual SIRs on an HPC-type substrate.

### DETAILED DESCRIPTION OF EXAMPLE EMBODIMENTS

The self-limiting nature of the ALD process enables the formation of film layers with precision on the atomic or molecular scale. Among those skilled in the art, ALD layer thickness is typically expressed as an average thickness. A contiguous monolayer is one molecule thick. However, a non-contiguous monolayer, where there are empty spaces left between the deposited atoms, can be less than 1 molecule thick on average.

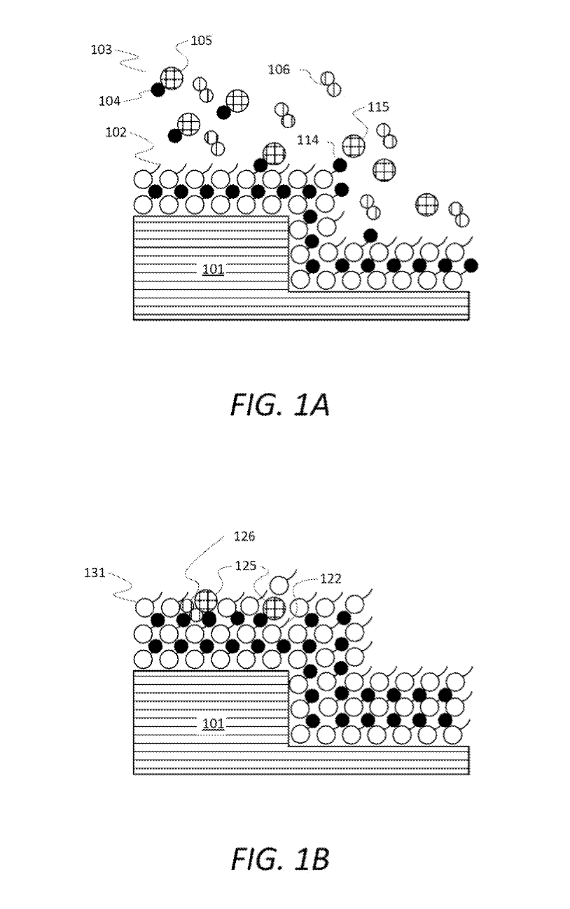

FIGS. 1A and 1B conceptually illustrate the effect of unwanted bonds in films. In FIG. 1A, substrate 101 has a reaction site 102 on its surface. An ALD precursor is introduced into the process chamber. Each precursor molecule 103 includes a deposition component 104 (an atom or molecule of the material being deposited) and a ligand 105. Besides precursor molecules 103, process gas molecules 106 may also be present in the process chamber. When a precursor molecule 103 encounters a reactive site 102, it reacts with reactive site 102 by chemical reaction, physical absorption, or some other mechanism. and thereby adsorbs to the surface. As a result of the reaction, deposition component 104 bonds with reactive site 102 as deposited material 114, and ligand 105 is detached to form by-product 115.

In FIG. 1B, two ligands 125 failed to detach from their deposition components and were trapped on the surface of substrate 101 by unwanted bonds. One of the ligands 125 blocked a reaction site 122, which failed to react. The other ligand 125 trapped a process gas molecule 126. The next layer 131 had some resulting disorder in its deposition. The extra trapped atoms or molecules 125 and 126, the unbonded reaction sites 122, and the disrupted parts of overlying layer 131 are all defects that can affect the performance of a layer, resulting from the adsorption of unwanted species.

Ligands trapped by unwanted bonds may include hydroxyl (—OH), amidogen (—NH₂), methyl (—CH₃), and halides from various ALD precursors, such as those for metals. Reactive process gases such as hydrogen and oxygen, and plasma-activated radicals from plasma treatments, may also become trapped on substrates through various mechanisms. Some unwanted bonds may be formed by species adsorbed to the surface even before ALD begins, for example by residues from cleaning processes or incompletely removed by-products of other fabrication steps.

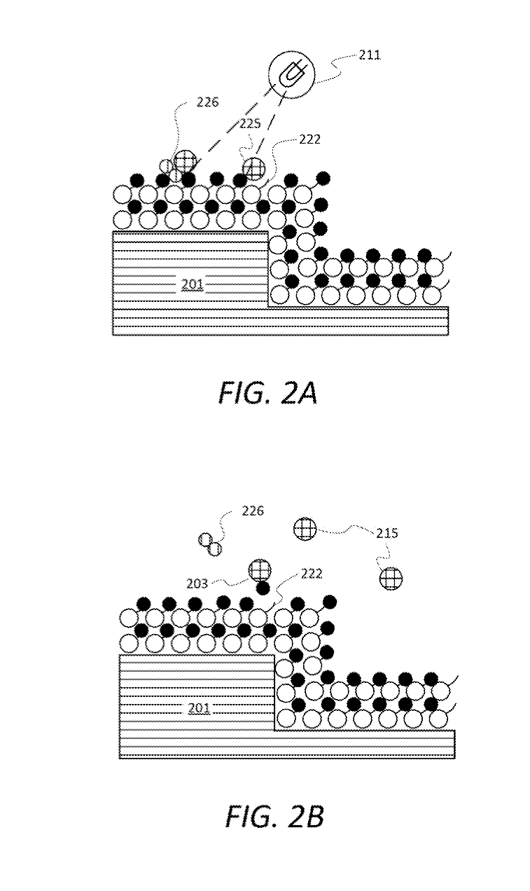

FIGS. 2A and 2B conceptually illustrate UV optical cleaving of targeted bonds. In FIG. 2A, UV source 211 irradiates substrate 201, where ligands 225 are blocking reactive site 222 and trapping process gas molecule 226. The spectrum of UV source 211 includes a wavelength of at least the dissociation energy of the targeted bond (in this case, between the deposition component and the ligand of the precursor). The relationship between energy and wavelength is given by the Planck relation E=(hc)/λ, where E=energy, h=Planck's constant, c=speed of light in vacuum, and λ=wavelength.

In FIG. 2B, the interaction of the UV light with the targeted ligand bonds has freed by-products 215 and process gas molecule 226 to be purged from the chamber. Additional precursor 203 can now be introduced to react with unreacted site 222.

In some cases, irradiating with a dissociation-energy wavelength may be unfeasible (e.g., if the wavelength is not generated by available light sources) or inconvenient (e.g., light at that wavelength damages or otherwise changes the characteristics of a desired feature on the substrate). An alternative is to choose a wavelength that will excite the targeted bond and facilitate cleaving by other means. Excitation wavelengths are often longer, and may be easier to obtain, than dissociation wavelengths. Excitation wavelengths often correspond to peaks in the absorption spectra of molecules comprising the targeted bonds (e.g., precursors or ligands).

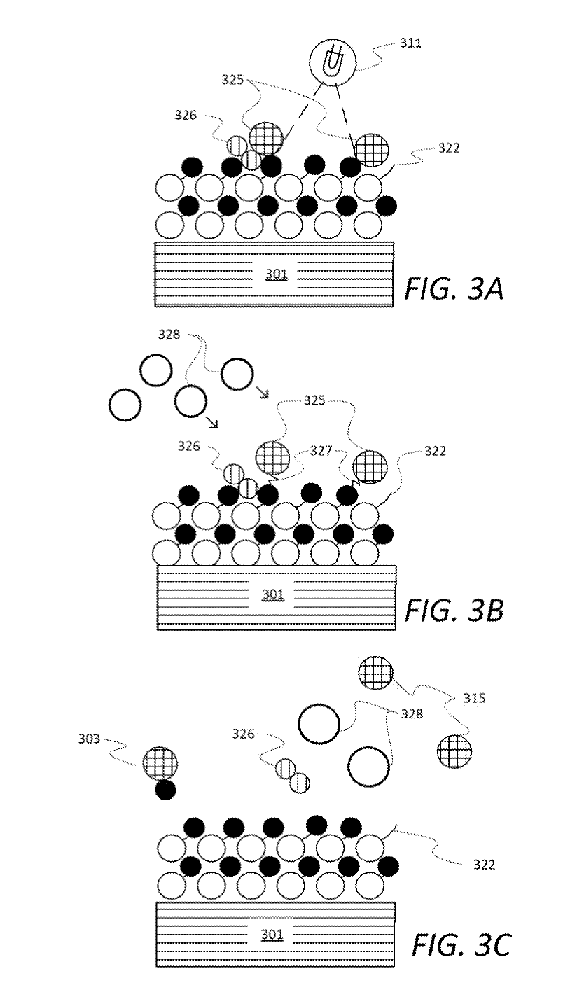

FIGS. 3A-3C conceptually illustrate UV excitation and subsequent cleaving of targeted bonds. In FIG. 3A, unwanted bonds have resulted in ligands 325 and process gas molecules 326 being trapped on substrate 301, and reactive site 322 being blocked and failing to react. UV light source 311 irradiates substrate 301. The spectrum of UV light source 311 includes a wavelength corresponding to a resonance of the bond between the deposition component and the ligand in the precursor. In FIG. 3B, the bonds 327 trapping ligands 325 on the surface of substrate 301 are excited, making them easier to break by collision or reaction. Gas molecules 328 are introduced into the process chamber to break excited bonds 327. The gas molecules 328 may be inert or reactive. In FIG. 3C, gas molecules 328 have freed by-products 315 and process gas molecule 326 by breaking excited bonds 327. In some embodiments, reactive gas molecules 328 may bond with by-products 315. Optionally, more precursor 303 may be let into the chamber to react with unreacted site 322.

For some embodiments of these processes, UV intensity at the substrate may range from about 1 to about 100 mW/cm². Irradiation time may range from about 1 to about 10 minutes. The ambient atmosphere in the chamber may be vacuum, oxygen, water vapor, ammonia, nitrogen, noble gas, or a precursor. As used herein, “vacuum” refers to pressures less than about 0.1 Torr. Some currently produced vacuum chambers can draw down to slightly less than 1e-12 Torr. However, the current state of the art does not limit the scope of invention because light is known to propagate through the much higher vacuum of outer space. Therefore, the described UV treatments could reasonably be expected to be compatible with future chambers capable of drawing higher vacuum, given a way to inject the light into those chambers. Substrate temperatures may be less than 250 C, or even less than 200 C, which can be advantageous when the substrate includes heat-sensitive materials such as sulfur-passivated germanium.

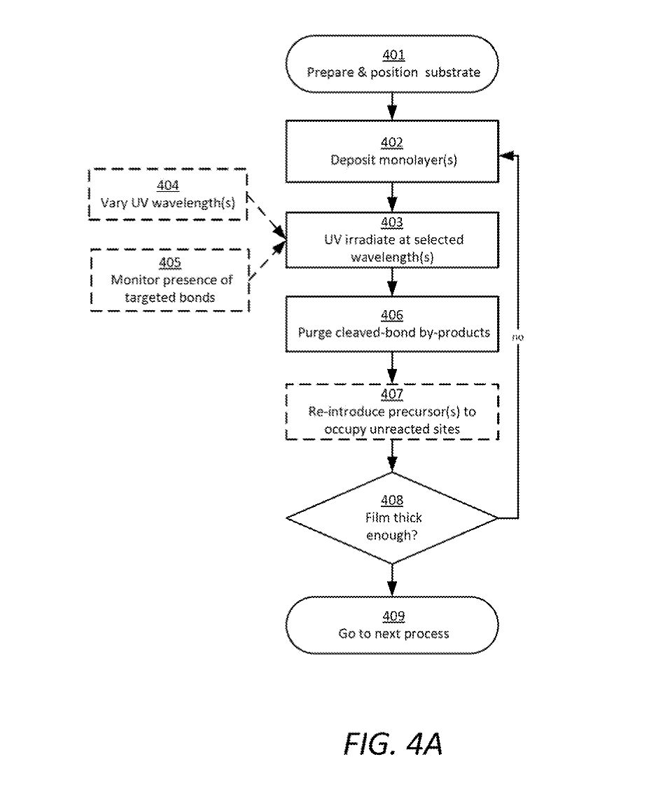

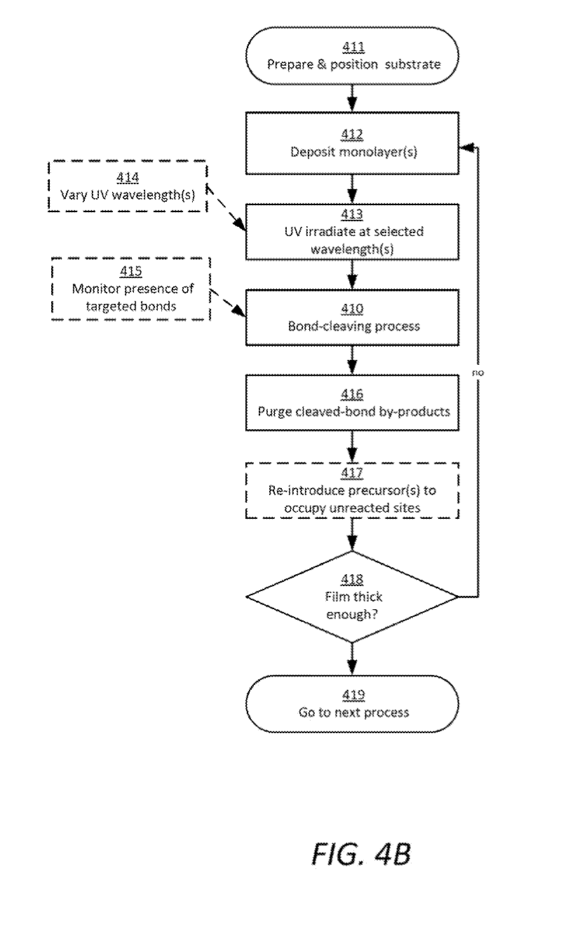

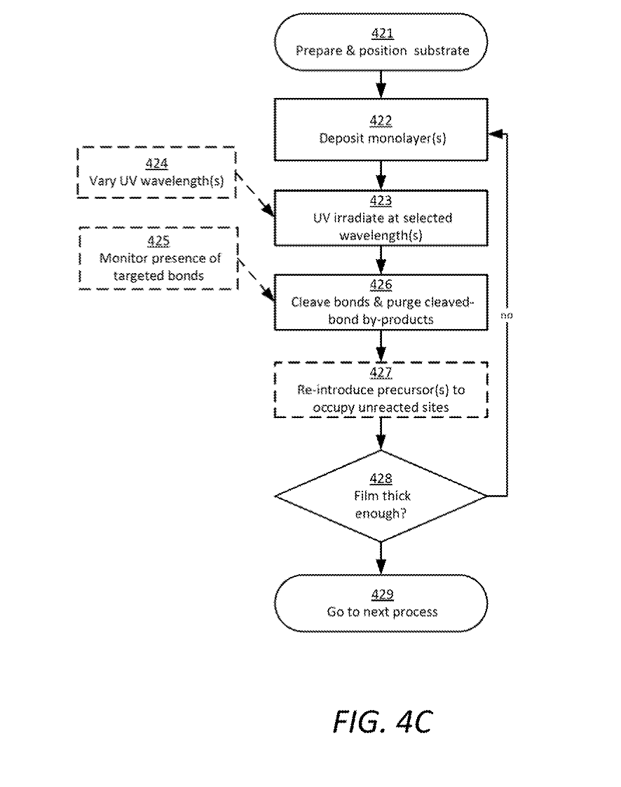

FIG. 4A-4C are example flowcharts of general ALD with UV irradiation treatment. In FIG. 4A, the UV light cleaves the targeted bonds. Initially, the substrate is prepared and positioned 401. One or more monolayers are deposited 402 by ALD when precursors let into the chamber partially adsorb onto the surface of the substrate. As used herein, “adsorption” may include chemisorption, physisorption, electrostatic or magnetic attraction, trapping, or any other interaction resulting in part of the precursor adhering to the substrate surface. “Partially adsorb” includes situations where some of the precursor molecules adsorb and some do not, or where parts of individual precursor molecules adsorb and others do not (e.g., where ligands detach from deposited material and become by-products). “Partially” does not exclude situations where the precursor is wholly adsorbed. The non-adsorbed portions of the precursors may be purged from the chamber. The deposited monolayers are irradiated 403 with UV light at wavelengths selected to cleave the targeted bonds that are expected from the deposition parameters. For example, if silicon oxide is being deposited with a silicon-containing precursor, unwanted silanol bonds may form. Silanol bonds can be dissociated by 172 nm or 222 nm light. In some embodiments, the UV wavelength may be varied 404. In some embodiments, a broadband UV source may be used to provide a wide range of wavelengths. In some embodiments, some of the UV wavelengths may be selectively blocked to avoid cleaving intentional bonds on the substrate (for example, the bond between silicon and oxygen in the silicon oxide). Optionally, the presence of the targeted bonds may be monitored 405 during the UV irradiation 403, for example by Fourier transform infrared (FTIR) spectroscopy, fluorescence spectroscopy, or other measurements.

During or after the UV radiation 403, the chamber is purged 406 to remove the by-products and any other impurities once the targeted bonds are cleaved. Optionally, additional precursor may be introduced 407 into the chamber to bond with any empty reactive sites exposed by the cleaving of the targeted bonds. If the film has not reached a desired thickness, 408 one or more additional monolayers are deposited 402 and the process is repeated. If the film has reached a desired thickness, 408 the process ends and a subsequent process can begin. Depending on the devices being fabricated, a desired thickness can range from angstroms to hundreds of nanometers.

In FIG. 4B, the UV light excites the bonds and the cleaving is done by a separate process, such as collision or reaction with gas or with activated plasma species such as radicals. Initially, the substrate is prepared and positioned 411, and one or more monolayers are deposited 412. The deposited monolayers are irradiated 413 with UV light at wavelengths selected to excite the targeted bonds that are expected from the deposition parameters (for example, peaks in the targeted bond's UV absorption spectrum). In some embodiments, the UV wavelength may be varied 414. In some embodiments, a broadband UV source may be used to provide a wide range of wavelengths. In some embodiments, some of the UV wavelengths may be selectively blocked to avoid exciting desired bonds on the substrate, such as those between the intentionally deposited materials.

The bond-cleaving process 410 (e.g., exposing the substrate to a gas or plasma) may follow the UV irradiation 413 or be done concurrently with the UV irradiation 413. The UV absorbance spectra of the gas or plasma-activated species may determine whether to irradiate and cleave the bonds sequentially or concurrently; the ambient atmosphere preferably does not absorb the selected bond-excitation wavelengths before they reach the substrate. Optionally, the presence of the targeted bonds may be monitored 415 during the bond-cleaving process 410 by FTIR, fluorescence spectroscopy, or other measurements.

During or after the bond-cleaving process 410, the chamber is purged 416 to remove the by-products and any other impurities once the targeted bonds are cleaved. Optionally, additional precursor may be introduced 417 into the chamber to bond with any empty reactive sites exposed by the cleaving of the targeted bonds. If the film has not reached 418 a desired thickness, one or more additional monolayers are deposited 412 and the process is repeated. If the film has reached 418 a desired thickness, the process ends and a subsequent process can begin. Depending on the devices being fabricated, a desired thickness can range from angstroms to hundreds of nanometers.

In FIG. 4C, the bond-cleaving is done by purge-gas collisions so that the bond-cleaving and purging of the bond-cleaving by-products take place in a single process. The substrate is prepared and positioned 421, and one or more monolayers are deposited 422. The deposited monolayers are irradiated 423 with UV light at wavelengths selected to excite the targeted bonds. The UV wavelength may be varied 424, or a broadband UV source may provide a wide range of wavelengths, or some of the UV wavelengths may be selectively blocked to avoid exciting desired bonds on the substrate.

The bond-cleaving process 426 doubles as a purge; for example, a noble gas such as argon may break the excited bonds by collision and flush the by-products out of the process chamber. Bond-cleaving process 426 may follow UV irradiation 423 or be done concurrently with UV radiation 423. The UV absorbance spectra of the gas or plasma-activated species may determine whether to irradiate 423 and cleave/purge 426 sequentially or concurrently. Optionally, the presence of the targeted bonds may be monitored 425 during the cleave/purge 426 by FTIR, fluorescence spectroscopy, or other measurements. After the cleave/purge 426, additional precursor may optionally be introduced 427 to bond with any empty reactive sites. If the film has not reached 428 a desired thickness, one or more additional monolayers are deposited 422 and the process is repeated. If the film has reached 428 a desired thickness, the process ends and a subsequent process can begin. Depending on the devices being fabricated, a desired thickness can range from angstroms to hundreds of nanometers.

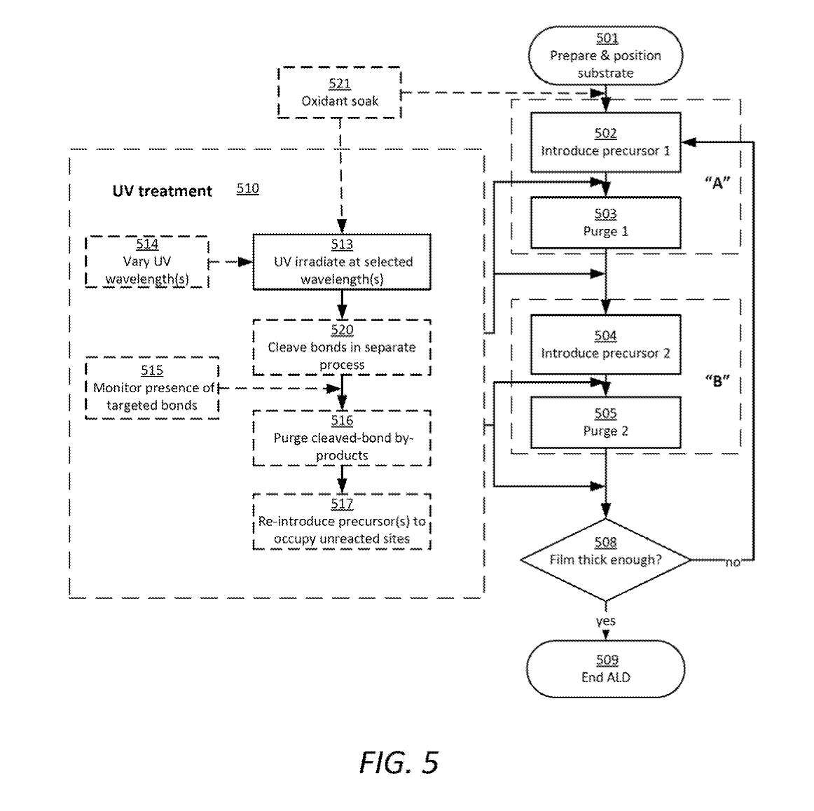

FIG. 5 is an example flowchart of “A-B cycle” ALD with UV irradiation treatment. A substrate is prepared and positioned 501. In the “A” cycle, a first precursor is introduced 502. If a metal oxide is being deposited, this may be the metal precursor; for example, trimethylaluminum ((CH₃)₃Al, “TMA”), triisobutylaluminum (CH₃)₂CHCH₂]₃Al), tris(dimethylamido)aluminum(III) (Al(N(CH₃)₂)₃), or aluminum tris(2,2,6,6-tetramethyl-3,5-heptanedionate) (Al(OCC(CH₃)₃CHCOC(CH₃)₃)₃), another aluminum precursor, or a precursor for hafnium or zirconium such as bis(tert-butylcyclopentadienyl)dimethylhafnium(IV), dimethylbis(cyclopentadienyl)hafnium(IV), hafnium(IV) tert-butoxide, tetrakis(diethylamido)hafnium(IV), bis(cyclopentadienyl)zirconium(IV) dihydride, bis(methyl-η5-cyclopentadienyl)methoxymethylzirconium, or dimethylbis(pentamethylcyclopentadienyl)zirconium(IV). The precursor may be introduced as a “pulse” of inflowing precursor followed by a time delay when no further precursor is introduced but the precursor already in the chamber reacts with the substrate.

Optionally, the UV treatment 510 may also begin during this time delay. Next, the process chamber is purged 503 to remove any unreacted precursor or by-products from the reaction zone and other surfaces. The purge may include an evacuation of the chamber, a pulse of a purge gas, or a combination. Alternatively, the purge gas may flow continuously through the reaction zone throughout deposition. The purge gas may be an inert gas such as argon, nitrogen, or helium. Optionally, if the UV treatment 510 has already begun, and the UV wavelength was selected to excite the targeted bonds, purge 503 can also serve to break the excited bonds. Alternatively, UV treatment 510 may begin during or after purge 503.

In the “B” cycle, a second precursor is introduced 504. If a metal oxide is being deposited, this may be the oxygen precursor (oxidant); for example, water (H2O) or ozone (O3). This precursor may also be introduced as a “pulse” followed by a time delay. Optionally, UV treatment 510 may begin, or repeat, or repeat with different parameters, during this time delay. Next, the process chamber is purged 505 to remove any unreacted precursor or by-products. Optionally, if the UV treatment 510 has already begun, and the UV wavelength was selected to excite the targeted bonds, purge 505 can also serve to break the excited bonds. Alternatively, UV treatment 510 may begin during or after purge 505.

UV treatment 510 may be any variation or combination of those described with reference to FIGS. 4A, 4B, and 4C. The UV irradiation 513 may include wavelengths that either cleave or excite targeted bonds on the surface. The UV wavelength may be varied 514, or may be broadband, or some wavelengths may be selectively blocked. If the UV light excites the targeted bonds, UV treatment 510 may include a separate bond-cleaving process 520. The presence of the targeted bonds on the surface may be monitored 515, for example by FTIR, fluorescent spectroscopy, or other methods. If the by-products of the bond-cleaving are not purged in purge 503 or purge 505, UV treatment 510 may include a separate purge 516. Optionally, UV treatment 510 may include introduction of an additional precursor to react with any unreacted sites that were interfered with by the targeted bonds.

In some embodiments, an oxidant soak 521 may precede deposition of the first precursor to promote growth of the first monolayer. Either alternatively or in addition, an oxidant soak may precede UV treatment, and a UV wavelength may be selected to promote reaction between the oxidant and the surface. The soak duration may be between about 30 seconds and 10 minutes. The soak may involve letting gas into the chamber to a predetermined pressure, then stopping the inflow and outflow for the remaining duration. Alternatively, gas may be let into and optionally exhausted from the chamber throughout the duration of the soak. Optionally, the inflow and outflow may be adjusted to provide a constant pressure in the chamber. The oxidant may include H₂O₂, H₂O, or O₃,

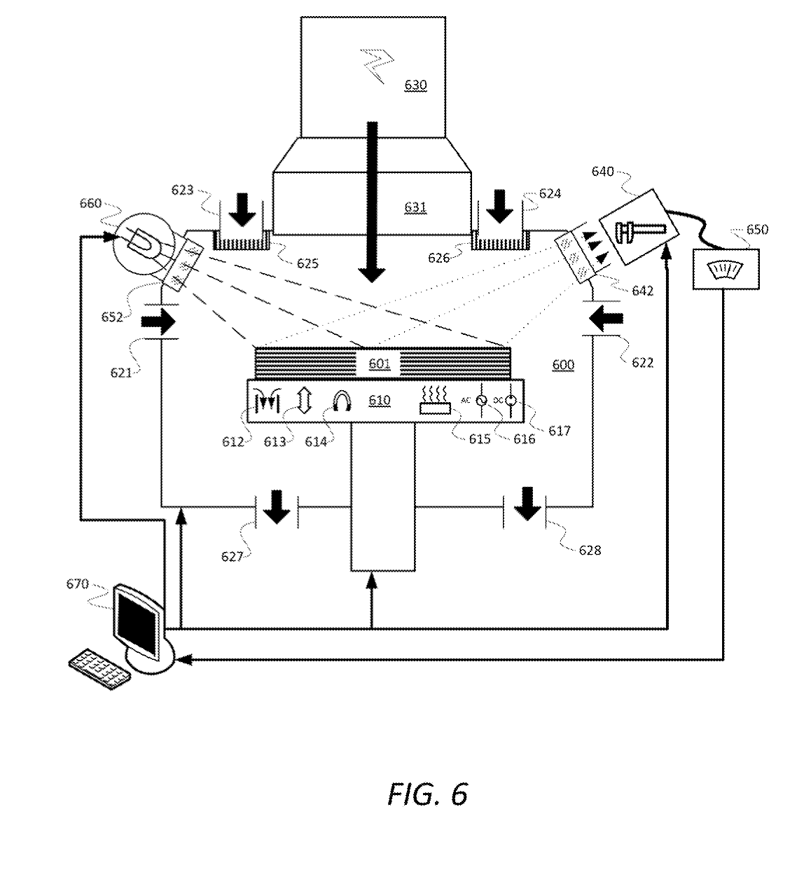

FIG. 6 is a schematic diagram of an ALD chamber equipped for UV treatment of substrates. Inside ALD chamber 600, substrate 601 is held by a substrate holder 610. Substrate holder 610 may be configured with vacuum 612 (for example, a vacuum chuck to grip the substrate); motion 613 in any direction, which may include tilt and rotation; a magnetic field source 614; heater or temperature control 615; or sources of AC 616 or DC 617 bias voltage. Chamber 600 also has gas inlets 621, 622, 623, 624 for precursors, buffer gases, and purge gases. Some of the inlets may feed through diffusers 625, 626. A remote plasma chamber 630 may generate reactive species that enter chamber 600 through input adapter 631. Measurement system 640 may monitor substrate 601 through measurement ports 642. The measurements from measurement system 640 may be collected by a monitoring system 650.

UV light source 660 irradiates substrate 601 through irradiation port 662. UV light source 660 may include a lamp, a light emitting diode, a laser, or a combination. UV light source 660 may be equipped with filters, gratings, prisms, or other wavelength selection optics. UV light source 660 may also include apertures and beam-shaping optics such as lenses or mirrors. UV light source 660 includes one or more power supplies for the light generating elements and any movable parts and control systems. Along with the substrate holder 610, the gas and plasma inlets and outlets to chamber 600, measurement system 640, and monitoring system 650, UV light source 660 may be controlled by a chamber control system such as computer 670.

Some process chambers can independently process separate site-isolated regions (SIRs) with different sets of process parameters on a single substrate; for example, the High Productivity Combinatorial (HPC) system described in U.S. Pat. No. 7,947,531 (incorporated herein by reference for all purposes). With the appropriate hardware configurations and software controls, the parameters of the UV treatments can be included as combinatorial variables. Parameters of UV treatment that can be varied by control of the light source may include average intensity, intensity variation with position on the substrate, exposure time, incident angle, and wavelength(s).

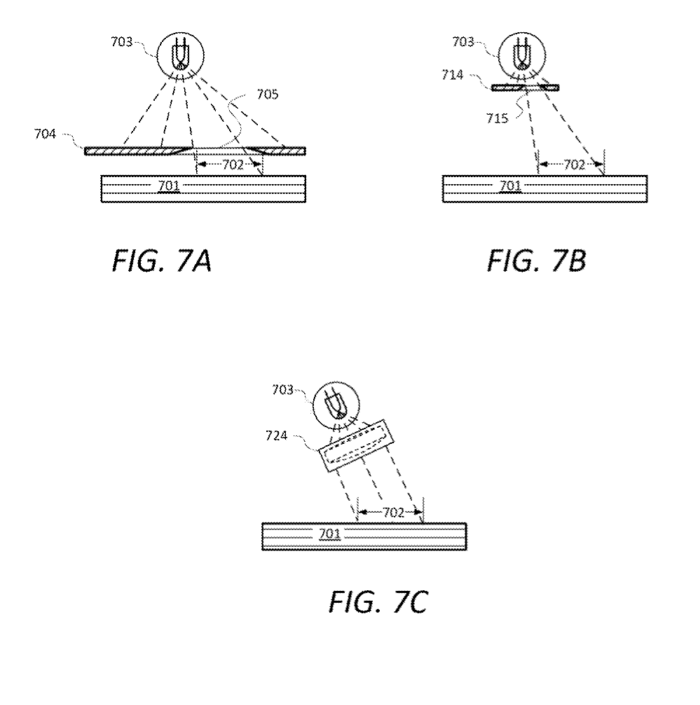

FIGS. 7A-7C are schematic diagrams of UV light sources selectively irradiating individual SIRs on an HPC-type substrate. In FIG. 7A, SIR 702 is defined on substrate 701. Substrate mask 704, made of a UV-reflecting or UV-absorbing material, is positioned over substrate 701 with aperture 705 between UV light source 703 and SIR 702. The aperture 705 may be a simple through-hole in mask 704, or it may include a UV-transparent window or a partially UV-transparent filter. Substrate mask 704 thus allows UV light to irradiate SIR 702, but not the rest of substrate 701. To irradiate a different SIR on the substrate, substrate 701 may move independently of mask 704 to expose a different SIR under aperture 705. A number of available substrate holders are capable of moving a substrate independently of the substrate mask. Alternatively, substrate 701 may be stationary while mask 704, with or without UV light source 703, moves to expose a different SIR under aperture 705.

In FIG. 7B, light from UV light source 703 confined to SIR 702 by an aperture stop 714 that restricts the angular range of illumination from UV source 703 according to the size of the aperture 715 and its distance from the UV source 703. In some embodiments, if the UV light source 703 includes a prism or grating to angularly separate its output wavelengths, aperture 715 may also restrict the range of wavelengths irradiating SIR 702. As with aperture 705 in the substrate mask 704, aperture 715 in aperture stop 714 may be a through-hole or may include a window or filter. To irradiate a different SIR, substrate 701 may move, or aperture stop 714 and light source 703 may move. Aperture steps 714 and light source 703 may either move by translation or may tilt to another angle so that the emerging cone of light falls on a different SIR.

In FIG. 7C, light from UV light source 703 is confined to SIR 702 by beam-shaping optics 724. The beam-shaping optics 724 may include lenses, windows, mirrors, and other components. In the illustration, the beam is largely collimated (neither converging nor diverging). In some embodiments, the light may converge or diverge or form an image on the SIR 702. To irradiate a different SIR, substrate 701 may move, or beam-shaping optics 724 and light source 703 may move in translation or tilt. Some embodiments of beam-shaping optics 724 may include a gimbaled mirror or window to move the beam of light without moving the entire assembly.

Although the foregoing examples have been described in some detail to aid understanding, the invention is not limited to the details in the description and drawings. The examples are illustrative, not restrictive. There are many alternative ways of implementing the invention. Various aspects or components of the described embodiments may be used singly or in any combination. The scope is limited only by the claims, which encompass numerous alternatives, modifications, and equivalents.

What is claimed is:

1. A method of atomic layer deposition, the method comprising:
placing a substrate in a process chamber;
exposing the substrate to a first precursor wherein a portion of the first precursor adsorbs onto a surface of the substrate;
purging a non-adsorbed portion of the first precursor from the process chamber; and
irradiating the substrate with ultraviolet light;
wherein a wavelength of the ultraviolet light is selected to cleave or excite a bond between an adsorbed species and the surface.

2. The method of claim 1, wherein the wavelength has an energy equal to or greater than the dissociation energy of the bond.

3. The method of claim 1, wherein the wavelength corresponds to an absorption peak of a molecule comprising the bond; and wherein the method further comprises a bond-cleaving process to cleave an excited bond.

4. The method of claim 3, wherein the bond-cleaving process comprises a collision or reaction with a gas molecule or a plasma-activated species.

5. The method of claim 4, wherein the gas molecule is a purge-gas molecule.

6. The method of claim 5, wherein the bond-cleaving process is combined with the purging of the process chamber.

7. The method of claim 1, wherein the wavelength is between about 150 nm and about 300 nm.

8. The method of claim 1, wherein the bond comprises a bond in or with a component of a precursor, a process gas, a cleaning composition, or a residue from a previous fabrication process.

9. The method of claim 1, wherein a temperature of the substrate is less than about 250 C.

10. The method of claim 1, wherein an intensity of the ultraviolet light is between about 1 and about 100 mW/cm².

11. The method of claim 1, wherein an irradiation time of the ultraviolet light is between about 1 second and about 10 minutes.

12. The method of claim 1, wherein an ambient atmosphere in the process chamber comprises at least one of vacuum, oxygen, water vapor, ammonia, nitrogen, noble gas, or the first precursor.

13. The method of claim 1, further comprising soaking the substrate in an oxidant before the substrate is exposed to the first precursor or before the substrate is irradiated with the ultraviolet light; wherein the soaking comprises introducing the oxidant into the chamber until a predetermined pressure is reached and stopping the inflow and outflow for between about 30 seconds and 10 minutes.

14. The method of claim 1, further comprising soaking the substrate in an oxidant before the substrate is exposed to the first precursor or before the substrate is irradiated with the ultraviolet light; wherein the soaking comprises maintaining an inflow of the oxidant into the chamber for between about 30 seconds and 10 minutes.

15. The method of claim 1, further comprising purging a by-product of the cleaving of the bond from the process chamber; wherein the by-product is purged after or while the substrate is irradiated with the ultraviolet light.

16. The method of claim 1, further comprising:
exposing the substrate to a second precursor, wherein a portion of the second precursor adsorbs onto a surface of the substrate; and
purging a non-adsorbed portion of the second precursor from the process chamber;
wherein the ultraviolet light irradiates the substrate before, during, or after purging of the non-adsorbed portion of the first precursor or the second precursor.

17. The method of claim 16, wherein the first precursor comprises a metal.

18. The method of claim 16, wherein the first precursor comprises aluminum, hafnium, or zirconium.

19. The method of claim 16, wherein the first precursor comprises trimethylaluminum ((CH₃)₃Al, “TMA”), triisobutylaluminum (CH₃)₂CHCH₂]₃Al), tris(dimethylamido)aluminum(III) (Al(N(CH₃)₂)₃), or aluminum tris(2,2,6,6-tetramethyl-3,5-heptanedionate) (Al(OCC(CH₃)₃CHCOC(CH₃)₃)₃), bis(tert-butylcyclopentadienyl)dimethylhafnium(IV), dimethylbis(cyclopentadienyl)hafnium(IV), hafnium(IV) tert-butoxide, tetrakis(diethylamido)hafnium(IV), bis(cyclopentadienyl)zirconium(IV) dihydride, bis(methyl-η5-cyclopentadienyl)methoxymethylzirconium, or dimethylbis(pentamethylcyclopentadienyl)zirconium(IV).

20. The method of claim 16, wherein the second precursor comprises an oxidant.
